(19) United States
(12) Patent Application Publication
(10) Pub. No.: US 2008/0066819 A1
(43) Pub. Date: Mar. 20, 2008

(54) Devices and method for transporting a container

(76) Inventor: KIMBERLY L. ATTANASIO, Niskayuna, NY (US)

Correspondence Address: SCHMEISER, OLSEN & WATTS, 22 CENTURY HILL DRIVE, SUITE 302, LATHAM, NY, 12110, US

(21) Appl. No.: 11/532,237

(22) Filed: Sep. 15, 2006

(51) Int. Cl. B60P 3/22

(52) U.S. Cl. 137/899; 220/562

(57) ABSTRACT

A receptacle configured to accept a container, a cart which can releasably accept a receptacle, and method for use of the receptacle and cart.

### FIELD OF THE INVENTION

The present invention generally relates to a receptacle and cart for transporting a container and related method. In particular, the present invention relates to a receptacle and method for transporting a container in a vehicle, where the receptacle is adapted to attach to a cart, and the cart is adapted to accept and transport the receptacle after it is removed from a vehicle.

### BACKGROUND OF THE INVENTION

Chlorine sanitizers for use in swimming pools, home spas, and hot tubs may include chemicals such as sodium hypochlorite, trichloro-s-triazinetrione, sodium dichloro-s-triazinetrione, lithium hypochlorite, or calcium hypochlorite. These chemicals may often be referred to, with regard to pool maintenance, simply as “chlorine”. In the case of bromine containing sanitizers such as 1-bromo-3-chloro-5,5-dimethylhydantoin and sodium bromide, these chemicals may often be referred to simply as “bromine”. While these chemicals may be relatively safe and effective in sanitizing swimming pool, home spa, and hot tub water, in concentrated form they can be extremely corrosive compounds and potent oxidizers. Due care in their handling may be needed and, as such, individuals maintaining a swimming pool may need to exercise caution when handling and transporting these materials.

Private swimming pools may be maintained personally by individual owners who may purchase pool chemicals themselves at a local supply store and who may transport them in their own vehicles. Placing a container of chlorine in a car may create a hazard due to common motion associated with turning, braking, and acceleration. An unsecured container may risk opening and spilling its contents in the vehicle. In addition, a person carrying such a container from their vehicle to a location in their backyard or near their pool, may have trouble negotiating the heavy load without brushing the container against their skin or pant leg. Residue on the exterior of the container may brush off and damage clothing or cause chemical burns on skin.

There exists a need for a device and method for transporting a container within a vehicle, and further for transporting the same container to a location after removing the container from the vehicle.

### SUMMARY OF THE INVENTION

The present invention relates to a receptacle comprising;
a base member;
at least one container opening having sides configured to tightly engage a container, said container opening disposed on a top of said base member and configured to accept a chlorine container; and a portion of said base member being configured to releasably attach to a cart.

The present invention relates to a method for transporting a chemical container comprising the steps of:
providing a chemical container receptacle, wherein said receptacle has at least one opening to tightly engage said container;
placing said chemical container into said opening;
placing said receptacle with said container into a vehicle;
transporting said receptacle with said chemical container;
removing said receptacle with said container from said vehicle; and
operably positioning wheels for transporting said receptacle.

The present invention relates to a transport device comprising:
a body and at least three wheels rotatably attached to axles, said axles being attached to said body, said body being configured to accept and releasably attach to a container receptacle; and
a handle pivotally attached to said body for pulling said body, wherein said body has at least one implement attached thereto for dispensing chemicals into a swimming pool.

A container receptacle comprising:
a base member;
at least one container opening configured to tightly engage a five gallon container, said container opening disposed on a top of said base member, said opening being configured to accept a substantially cylindrical container, said opening being additionally configured to accept a substantially rectangular container; and
a bottom of said base member further comprising an attachment device for reversibly attaching said receptacle to a transport vehicle.

The present invention provides a device and method for transporting a container within a vehicle, and further for transporting the same container to a location after removing the container from the vehicle.

### BRIEF DESCRIPTION OF THE DRAWINGS

The foregoing and other features and advantages of the present invention will be apparent from the following more detailed description of the particular embodiments of the invention, as illustrated in the accompanying drawings wherein:

FIG. 1 illustrates a perspective view of a receptacle within the scope of the present invention;

FIG. 2 illustrates an embodiment of the present invention with a single container opening for a container, within the scope of the present invention;

FIGS. 3a-c illustrate several embodiments of friction device on a section of an inverted underside of a receptacle base member, within the scope of the present invention;

FIG. 4 illustrates a receptacle with a cubic shaped opening for a rectangular container, within the scope of the present invention.

FIG. 5 illustrates one embodiment of a receptacle with a cart, within the scope of the present invention;

FIG. 6 illustrates a perspective view of a cart, within the scope of the present invention;

### DETAILED DESCRIPTION OF THE INVENTION

Although certain specific embodiments of the present invention will be shown and described in detail, it should be understood that generalizations and various changes and modifications may be made without departing from the scope of the appended claims. The scope of the present invention will in no way be limited to the number of constituting components, the materials thereof, the shapes thereof, the relative arrangement thereof, etc. Some features of the present invention are illustrated in detail in the accompanying drawings, wherein like reference numerals refer to like elements throughout the drawings. Although the drawings are intended to illustrate an embodiment of the present invention, the drawings are not necessarily drawn to scale.

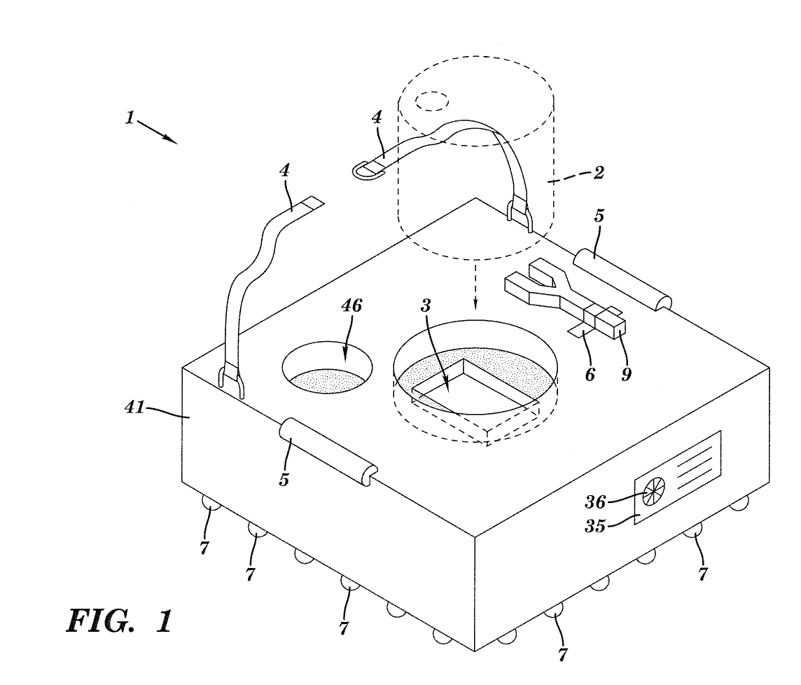

FIG. 1 illustrates an aspect of the invention wherein, a container receptacle 1 having a base member 41, said base member may have at least one container opening 3 disposed on a top side of said base member to accommodate and tightly accept a substantially cylindrical container 2, such as a five-gallon container of chlorine or other pool chemicals, wherein said opening 3 may occupy a substantial portion of said base member 41, and wherein said opening may be configured such that a container 2 may substantially fill said opening 3 when placed into said opening 3.

The container opening 3 may tightly engage, so as to hold and/or stabilize, a container 2 while the receptacle 1 is being transported in a vehicle, thus preventing spillage of said container's contents in a user's vehicle, such that said container 2 is not free to move about within container opening 3. A receptacle with an opening which does not secure or tightly engage a container, such as an open basket or bin, may risk spilling the contents of a container if it should fall over due to forces associated with accelerating, braking, and turning of a vehicle during transport. Tight engagement by the opening 3 may be accomplished by, for example, use of projections inside the opening 3, O-rings around the inner periphery of the opening, tight tolerance fitting of the container 2 to the opening 3 dimensions, a compression fit of the container 2 into opening 3, fittings such that the container 2 may “snap” into place in opening 3, or a friction device within opening 3 such as compressible, flexible padding.

The container opening 3 may be configured to accept either a cylindrical container, a cubic container, or a polygonal shaped container. A container opening 3 may be configured to accept a substantially cylindrical container 2, said container opening being additionally configured to accept a substantially rectangular container. A configuration which allows said container opening 3 to accept more than one shape of container, may offer the advantage of flexibility of use.

Contoured handles 5 may be attached to opposing ends of said base member 41 and may assist a user when lifting said receptacle.

A safety strap 4 may be attached to said base member 41 and may be used to secure said containers to said receptacle 1 during transport. The receptacle of FIG. 1 may additionally comprise a second opening 46 which may be smaller than the container opening 3. Said second opening 46 may be used for smaller chemical containers such as a single quart bottle.

A holding means or device 6 may be disposed on said base member 41, where said holding means or device 6 may be used for holding a implement or tool 9 such as a wrench for opening a chlorine container or other chemical container. Said holding means or device 6 may comprise at least one clip, hook, ring, hook-and-loop fastener (as exemplified in FIG. 1) such as VELCRO, opening, magnet, carabineer, snap, or any other means or device for holding.

An underside of said base member 41 may have a plurality of friction means or devices 7 for assisting in stabilizing and securing the receptacle within a vehicle during transport. The braking, turning, and accelerating of an automobile, for example, during transport may cause undesired movement of a container not placed in a receptacle as disclosed in the present invention. Said friction means or devices may include at least one suction cup, rib, spike, hook-and-loop fastener such as VELCRO, rubber pad, or any other means or device for friction. Said friction means or device may provide stability to said receptacle 1 while being transported in a vehicle. The bottom of the base member 41 may also be configured so that it can be attached to and easily released from a cart. FIG. 1 also depicts a content sensor 35 attached to base member 41. Said content sensor 35 may allow the user to determine if the container 2 is full. The content sensor 35 may further comprise a weight measurement means or device such as an electronic scale, a mechanical spring scale, a strain gauge, or any others means or device for measuring weight, where said weight measurement means or device may provide the user with a weight of the container and contents. Alternatively said measurement means or device may provide only an indicator 36 that the container and contents are at a desired weight. The indicator 36 could include a visual alarm such as a flashing or steady light, an audible alarm such as a buzzer, a horn, or a bell, a tactile signal such as a vibrating indicator, or a mechanical indicator such as a dial or pointer.

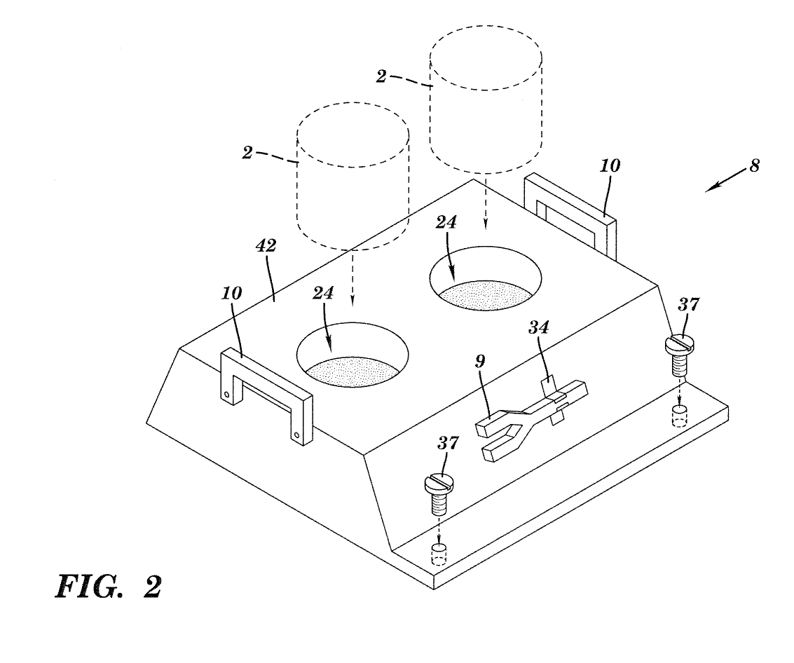

FIG. 2 depicts an embodiment of the invention where a receptacle 8 may have base member 42 with more than one container opening 24 to accommodate more than one container 2, wherein said openings 24 occupy a substantial portion of said base member 42. FIG. 2 also illustrates an alternative shape for a receptacle 8 wherein a bottom side of the base member 42 may be larger in area than a top side of the base member 42. Also, FIG. 2 illustrates an alternative form of the contoured handles 10 as opposed to the type of contoured handles 5 shown in FIG. 1.

The receptacle in FIG. 2 is shown with a container tool 9 secured with holding means or device 34 to the top of said base member 42. Said holding means or device 34 may alternatively consist of at least one clip (as exemplified in FIG. 2), hook, ring, hook-and-loop fastener such as VELCRO, molded-in opening, magnet, carabineer, snap, or any other means or device for holding.

FIG. 2 also contains threaded fasteners 37 as an example of a means or device for releasably attaching said receptacle 8 to a cart. Other means or devices may include at least one strap, buckle, hook-and-loop fastener such as VELCRO, or any other means or device for releasably attaching. The bottom of the base member 42 may also be configured so that it can be attached to and easily released from a cart. The receptacle may be dually configured to releasably attach to both a vehicle for transport and a cart for moving to a location such as a pool or chemical storage area.

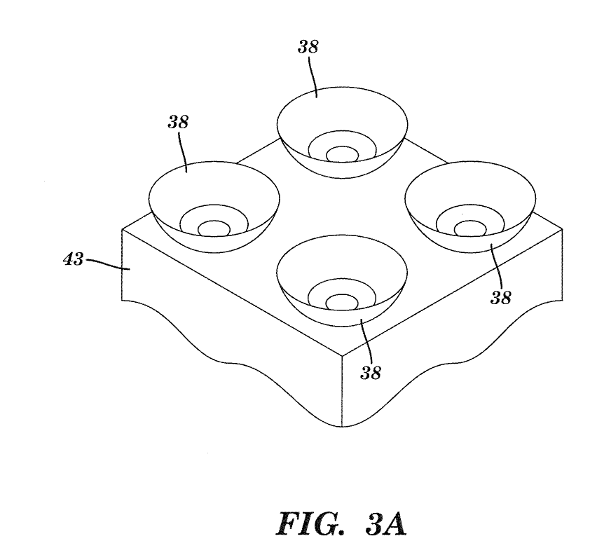

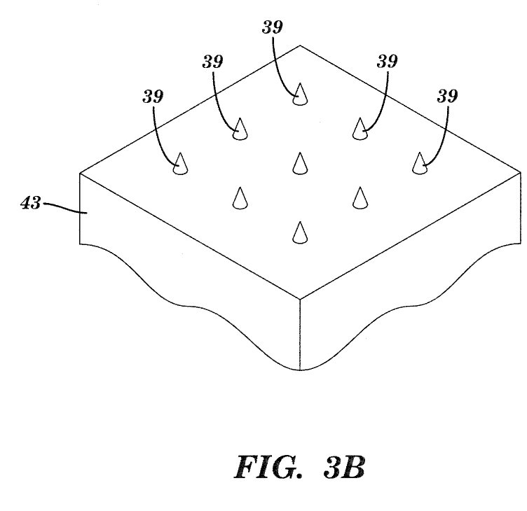

FIGS. 3a, 3b, and 3c illustrate several embodiments of a plurality of friction means or devices disposed on sections of an underside of a base member 43, which may secure and stabilize the receptacle of the present invention in a vehicle. As examples, suction cups 38 in FIG. 3a, spikes 39 in FIG. 3b, and ribs 40 in FIG. 3c are illustrated, however said friction means or device may alternatively include at least one hook-and-loop fastener, rubber pad, or any other means or device for friction.

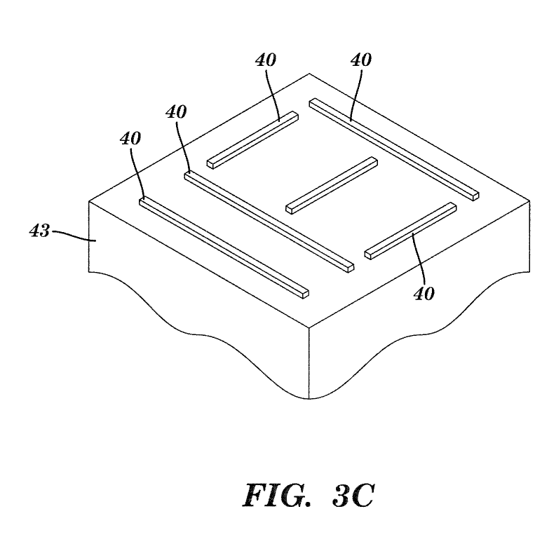

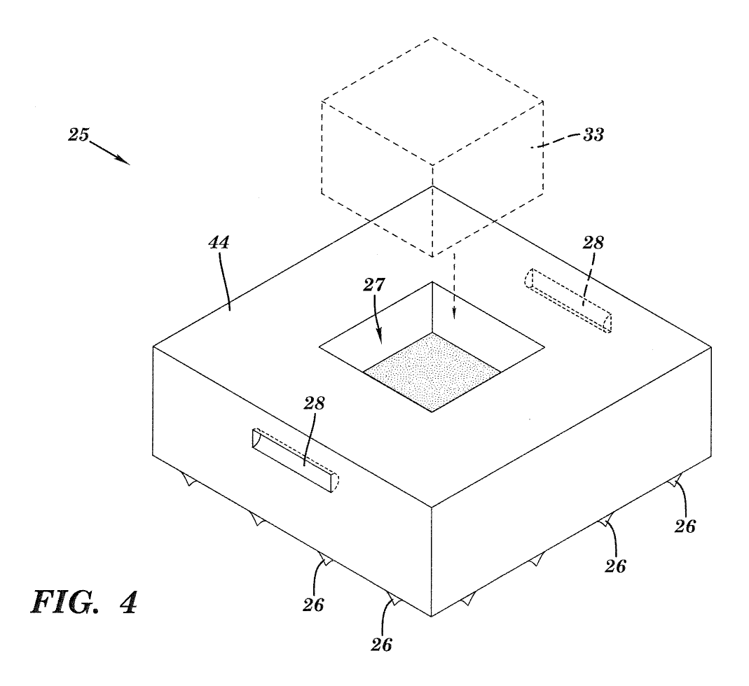

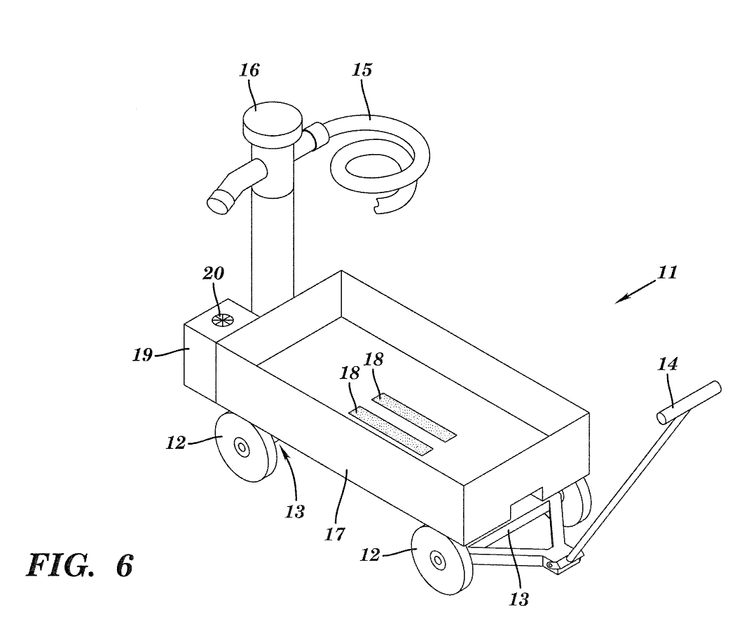

FIG. 4 illustrates a receptacle 25 with base member 44, where said base member 44 may have a substantially cubic opening 27, configured to accept a rectangular shaped container 33, wherein said opening 27 occupies a substantial portion of said base member 44. In addition, FIG. 6 depicts one embodiment of a friction means or device 26 which may assist in securing and stabilizing said receptacle 25 in a vehicle. The friction means or devices 26 in FIG. 4 are shown as small spikes which, for example, may penetrate into a vehicle carpet to prevent sliding as the vehicle turns, brakes, or accelerates. Other friction means or devices may include suction cups, ribs, spikes, hook-and-loop fasteners, a rubber pad, or any other means or device for friction. Suction cups and a rubber pad may provide stability on a hard smooth surface, such as in a metal or plastic pick-up truck bed, while ribs, spikes, and hook-and-loop fasteners may provide stability on a carpeted or otherwise porous surface such as vehicle floor carpeting. There may be additional frictions means or devices not specifically stated here which may provide an equivalent function. Contoured handles 28 may assist the user when lifting said receptacle 25 from a vehicle.

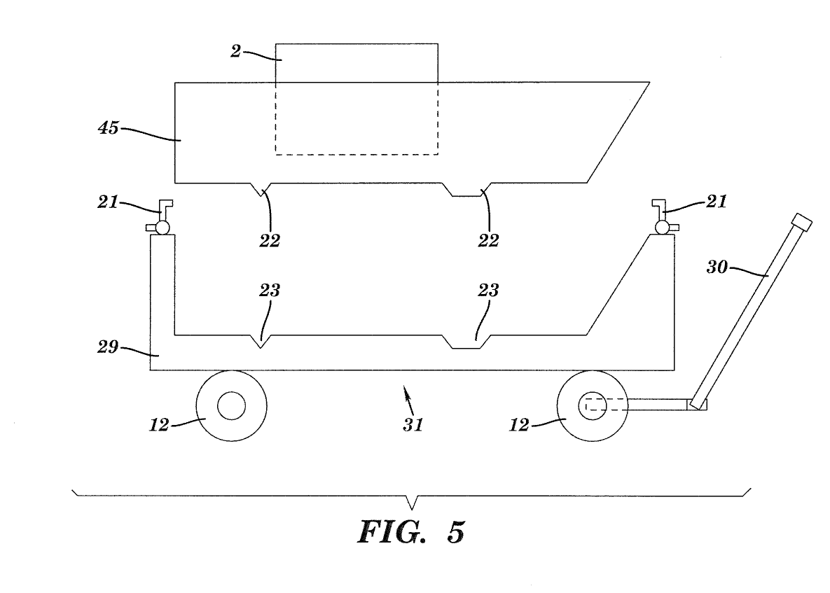

FIG. 5 illustrates a cart 31 which may be configured to accept a receptacle 45, and illustrates an example of a poka-yoke configuration which may allow the receptacle 32 to be attached to the cart 31 in only one position. Such a design may help position said container in a proper orientation with respect to stability or for access to a pumping means or device when dispensing chemicals from a container loaded into said receptacle 32. FIG. 5 illustrates an example of how protrusions 22, on a base member 45 of said receptacle 32, may match only their respective mating pair of openings 23 on the cart body 29. Such a configuration may include at least one molded-in feature, fitting, or geometric contouring on the bottom of the said base member 45, which may have corresponding mating features on the loading surface of the body of the cart 31, which may allow the receptacle 32 to fit into the cart 31 and be releasably secured and attached thereon. As an additional example, the base member 45 may be shaped to fit in only one direction onto the cart 31.

Clamps 21 in FIG. 5 are illustrated as an example of a releasable attachment means or device for releasably attaching said base member 45 to said cart 31. Clamps 21 may alternatively be mounted onto said receptacle 45. Means or devices for releasable attachment may alternatively include straps, buckles, threaded fasteners, clamps, hook-and-loop fasteners such as VELCRO, or any other means or device for releasable attachment. A cart handle 30 pivotally and operatively attached to said wheels 12, may allow for moving said cart 31 as well as steering and maneuvering.

The cart 11 in FIG. 6 depicts another embodiment of a cart for transporting a receptacle. The receptacle along with the container may be removed as a unit from a vehicle and placed on a cart 11 to be moved to the desired location such as by the pool or in a chemical storage area. Said cart 11 may have a body 17 and at least three wheels 12 rotatably attached to axles 13, said axles 13 may be attached to said body 17, and said body 17 may be configured to accept and releasably attach to a container receptacle base member.

In the embodiment in FIG. 6, said cart 11 may have VELCRO strips 18 to releasably attach a container base member with corresponding mating VELCRO strips. Alternative means or devices for releasably attaching said cart 1 to a container receptacle base member may include straps, buckles, threaded fasteners, clamps, or any other means or device for releasable attachment. The cart 11 may further comprise a cart handle 14 pivotally attached to said cart 11 for pulling said cart 11 to a desired location, for example. Said cart handle 14 may also be operatively attached to the wheels 12 and at least one of the axles 13 of said cart 11 for steering said cart. Said cart handle 14 may be operatively attached such that said cart handle 14 may be retractable under said body 17 of said cart 11. Alternatively, the cart handle 14 could telescopically fold into itself to reduce its size, or be removable from said cart 14.

The overall design of the body of cart in the present invention may be constructed to have sides and may at least partially enclose a receptacle as in FIG. 6, may substantially comprise a framework with open sides or lattice of support for a receptacle as in FIG. 5, or may comprise a combination of these two configurations.

A three-wheeled cart may be adequate to carry a receptacle and still allow for steering, although additional wheels and axles may provide additional strength, stability, and maneuverability to the cart 14. The wheels 12 may be retractable either into a side of said cart 14 or under the body 17 of the cart 14. Alternately, said wheels 12 may be removable. When said cart 14 is not in use, said wheels 12 may be retracted or may be removed. When cart 14 is in use, said wheels 12 may be reattached, or may be moved from a retracted position and into an operable position, for transporting a load such as a receptacle.

FIG. 6 further illustrates implements attached to the cart which may assist in dispensing chemicals, where FIG. 6 illustrates a pump means or device 16 attached to said cart 11 as an implement which may draw a liquid chemical from a container; and a hose system 15 operatively attached to said pump means or device 16 which may dispense a liquid chemical drawn from a container using said pump means or device 16. Alternatively, a graduated scoop, measuring cup, or equivalent, may be attached to the cart body and used for dispensing solid chemicals. A wrench or other implement for opening a chemical container may also be attached to the cart body 11. The hose system 15 may also be attached to said cart body 11, to provide support and easy transport of said hose system 15. Such a hose system 15 and pump 16 may be made from chemically resistant materials to avoid corrosion and deterioration of the system.

Referring to FIG. 6, the cart 11 may further comprise a weight measurement means or device 19 operatively connected to said cart 11 for weighing a container, and an indicator 20 connected to said weight measurement means or device 19, such that said indicator 20 provides an alert when a container is greater than a specific weight. Said weight measurement means or device 19 may comprise an electronic scale, a mechanical spring scale, a strain gauge, or any other means or device for weight measurement. Locating the weight measurement means or device 19 on the cart 11, as opposed to locating said measurement means or device 19 on the receptacle 1 (as in FIG. 1), may allow for protection of the measurement means or device 19 from possible damage during transport of the receptacle 1.

A user of the present invention may place a 5-gallon container of pool chemical into a container opening in the base member of the receptacle, and then place the receptacle and container as a unit into a vehicle for transport. The base member may be secured to the vehicle, and the container may be secured to the base member. After transporting the container to the desired location, the user may release the base member from the vehicle, and then remove the receptacle and container together from the vehicle, and place the receptacle and container together onto a cart. The wheels of said cart may be moved to a position such that said wheels may be operably positioned for transportation. The base member may be attached to the cart, and the receptacle and container may be transported using the cart, such as pulling or moving said cart by hand, to the desired location such as the swimming pool or to the user's storage area for pool chemicals. In addition, a pumping means or device may be attached to said cart, and a hose system may be attached to said pumping means or device. A user may use said pumping means or device and said hose system to dispense a liquid chemical from a container placed in said receptacle and loaded onto said cart, into, for example, another container, pool treatment system, or directly into a swimming pool.

The invention may be composed of such materials as reinforced and non-reinforced plastic, fiberglass composite, metal, carbon fiber, or a combination of these materials to provide a suitably rigid, durable structure for supporting the weight of the item being transported, such as a 5-gallon container of fluid. There may be advantages to each material, such as a relatively lighter weight and lower cost of plastics, and a relatively higher strength of carbon fiber composites. The above described cart and receptacle of the present invention may be made from chemically resistant materials to avoid corrosion and deterioration of the system, such as may be caused by spillage of pool chemicals for example. Additional advantages and disadvantages of each material may be apparent to those skilled in the art, and an appropriate material may be chosen based on said advantages and disadvantages.

The foregoing description of the present invention has been presented for purposes of illustration and description. It is not intended to be exhaustive or to limit the invention to the precise form disclosed, and many modifications and variations are possible in light of the above teaching. For example, a content sensor may include a pressure sensitive pad with an accompanying controller means or device to determine the weight of the container. Such modifications and variations that may be apparent to a person skilled in the art are intended to be included within the scope of this invention as defined by the accompanying claims.

What is claimed:

1. A receptacle comprising;
a base member;
at least one container opening having sides configured to tightly engage a container, said container opening disposed on a top of said base member and configured to accept a chlorine container; and a portion of said base member being configured to releasably attach to a cart.

2. The receptacle of claim 1 further comprising a container content sensor operatively attached to said base member such that the weight of a container placed in said container opening may be determined.

3. The receptacle of claim 2 where said container content sensor further comprises a weight measurement device, where said weight measurement device is at least one of an electronic scale, a mechanical spring scale, or a strain gauge.

4. The receptacle of claim 2 wherein said container content sensor further comprises an indicator in communication with said container content sensor for signaling when container is almost empty.

5. The receptacle of claim 1 further comprising said base member having two opposing ends, said ends having a contoured handle each attached thereon.

6. The receptacle of claim 1 where said receptacle is composed of at least one of metal, plastic, fiberglass composite, or carbon fiber.

7. The receptacle of claim 1 further comprising a safety strap, said strap attached to said base member in two locations to secure said container placed inside said container opening.

8. The receptacle of claim 1 wherein the shape of said container opening is selected from the group consisting of substantially cylindrical, substantially cubic, and substantially polygonal.

9. The receptacle of claim 1 further comprising a holding device for holding a container opening tool, said holding device being attached to said base member;

10. The receptacle of claim 1 further comprising a plurality of friction devices attached to the underside of said base member.

11. The receptacle of claim 10 where said friction device is at least one of a suction cup, a rib, a spike, a hook-and-loop fastener, or a rubber pad.

12. The receptacle of claim 9 where said holding device is at least one of a clip, a hook, a ring, a hook-and-loop fastener, a molded-in opening, a magnet, a carabineer, or a snap.

13. The receptacle of claim 4 wherein said indicator is at least one of a visual signal, an audible signal, a tactile signal, or a mechanical indicator.

14. The receptacle of claim 1 further comprising an attachment device for releasably attaching said receptacle to a cart, said attachment device consisting of at least one of a hook-and-loop fastener, a snap, a magnet, a strap, a buckle, an elastic band, a clamp, or a hook.

15. A method for transporting a chemical container comprising the steps of:
providing a chemical container receptacle, wherein said receptacle has at least one opening to tightly engage said container;
placing said chemical container into said opening;
placing said receptacle with said container into a vehicle;
transporting said receptacle with said chemical container;
removing said receptacle with said container from said vehicle; and
operably positioning wheels for transporting said receptacle.

16. The method of claim 15 wherein said cart further comprises a pump device attached to said cart for pumping a liquid chemical from said container, and a hose system connected to said pump device for dispensing said liquid chemical from said pump.

17. The method of claim 16 further comprising connecting said pump device to said container and dispensing said liquid chemical from said hose system.

18. The method of claim 17 further comprising dispensing said chemicals into a swimming pool.

19. A transport device comprising:
a body and at least three wheels rotatably attached to axles, said axles being attached to said body, said body being configured to accept and releasably attach to a container receptacle; and
a handle pivotally attached to said body for pulling said body, wherein said body has at least one implement attached thereto for dispensing chemicals into a swimming pool.

20. The transport device of claim 19 further comprising a weight measurement device operatively connected to said transport device for weighing a container, and an indicator connected to said weight measurement device, such that said indicator provides an alert when said container is lighter than a specific weight.

21. The transport device of claim 20 wherein said weight measurement device is at least one of an electronic scale, a mechanical spring scale, or a strain gauge.

22. The transport device of claim 20 further comprising a pump device attached to said transport device for drawing a liquid chemical from a container; and a hose system attached to said pump device for dispensing a liquid chemical drawn from a container.

23. A container receptacle comprising:
a base member;
at least one container opening configured to tightly engage a five gallon container, said container opening disposed on a top of said base member, said opening being configured to accept a substantially cylindrical container, said opening being additionally configured to accept a substantially rectangular container; and
a bottom of said base member further comprising an attachment device for reversibly attaching said receptacle to a transport vehicle.
